(19) United States
(12) Patent Application Publication
(10) Pub. No.: US 2026/0252301 A1
(43) Pub. Date: Aug. 27, 2026

(54) ENHANCED CONTROLS FOR SENSORY GROUP TIMERS

(71) Applicant: Microsoft Technology Licensing, LLC, Redmond, WA (US)

(72) Inventors: Edward Richard EUCLIDE, Prague (CZ); Defne KUDELA, Prague (CZ); Tiphanie LAU, Prague (CZ); Dima Mohd Said Kamal STEITEYEH, Prague (CZ); Eleonora PORENA, Prague (CZ); Iva HORNAKOVA HRUBA, Prague (CZ)

(21) Appl. No.: 19/060,454

(22) Filed: Feb. 21, 2025

(51) Int. Cl. G06F 3/14; G06F 3/0481; G06F 3/0484

(52) U.S. Cl. CPC G06F 3/1454; G06F 3/0481; G06F 3/0484

(57) ABSTRACT

The disclosed techniques provide enhanced controls for sensory group timers. In an online conference, a system allows a user to designate a subgroup comprising a subset of the conference attendees. This subgroup can be a subset of attendees making a presentation in the meeting, a confidential subgroup in an online negotiation meeting, or any other subgroup that want a private group timer only displayed to them while they still maintain communication with the others outside of the subset of attendees. The system allows the subset of attendees to control the group timer that is to be shared only within the designated subset group in the online meeting that includes all of the attendees. The group timer is displayed to the subset without providing notifications showing the other users outside the subgroup that the group timer exists, while the subgroup is still sharing content with the others outside the subgroup.

### BACKGROUND

There are a number of different types of collaborative systems that allow users to communicate. For example, some systems allow people to collaborate by sharing content using video streams, audio streams, shared files, chat messages, etc. Some systems manage communication sessions, which are also referred to herein as online meetings, virtual reality sessions, broadcasts, etc. Such sessions can have a distinct start time and an end time that occur on specific dates. Some existing systems provide a number of tools that allow participants to share content in the form of audio streams, video streams, chat messages, screen sharing features, etc.

Although some existing systems provide a number of features that allow people to collaborate during specific events, some systems do not provide effective tools that help meeting participants coordinate specific tasks. For example, some existing systems only have one centralized meeting timer that automatically starts at the beginning of a meeting. In a scenario where multiple participants share a specific timeslot within a meeting for a presentation, the use of the centralized meeting timer requires everyone to manually manage that time on their own with no shared sense of time created. In addition, the use of a centralized meeting timer requires each presenter to take mental steps away from their presentation, as generic timers cause a need for presenters to repeatedly calculate the remaining time they have for a given timeslot and also coordinate that remaining time with other presenters. This can detract from a presentation as well as creating distractions for the audience.

In some cases, participants of a meeting can use a timer application, which may require a user to share a display of a timer to coordinate with other presenters. This may use a considerable amount of screen space and can be disruptive for some participants. In addition, it may not be desirable to share the status of a timer shared between a subgroup, particularly if that subgroup is in negotiations with the other attendees of a meeting. Furthermore, the display of traditional timers can generate distracting notifications, which generally lack sensory accommodations.

### SUMMARY

The techniques disclosed herein enable systems to provide enhanced controls for sensory group timers. In an online conference, a system allows a user to designate a subgroup comprising a subset of the meeting attendees. This subgroup can be a subset of attendees that are joint presenters in a meeting, a confidential subgroup in an online negotiation meeting, or any other subgroup of participants that benefit from a private group timer only displayed to them while they still maintain communication with the others outside of the subset of attendees. The system allows the subset of attendees to control the group timer that is to be shared only within the designated subset group in the online meeting that includes all of the attendees. The group timer is displayed to the subset without providing notifications showing the other users outside the subgroup that the group timer exists, while the subgroup is still sharing content, video streams, audio streams, files, and/or chat messages with the others outside the subgroup. The system utilizes permissions that prevent the group timer from being displayed on devices of those who are outside the subgroup.

The system also provides sensory accommodations that include customizations to visual notifications, sounds, and haptics that are less distracting than timers having traditional visualizations. In some embodiments, a system can generate animations integrated into a frame of a user interface or animations that are configured as a semi-translucent watermark image into a background of a user interface. The animations show depictions that discreetly indicate the progress of a timer without the use of intrusive notifications or unnecessarily use a large portion of a screen. For example, the disclosed techniques integrate an animation into a frame of a user interface that includes a sunrise animation to represent the start of a group timer and a sunset animation to represent end of a given time period. In another example, a background image of a meeting user interface may show an image of a city that starts as a daytime scene and transitions to a nighttime scene to indicate that a timer has reached the end of a given time period. Such animations can be coordinated with subtle sounds and haptic feedback to provide notifications to specific participants.

The features disclosed herein allow a system to provide a status of a timer while minimizing the use of screen space and allowing more room for shared content. These techniques also accommodate participants that may be sensitive to bright lights or other obtrusive notifications. In addition, the disclosed techniques generate animations that allow users to readily see the status of a timer for their specific tasks, without requiring meeting participants to take time away from their tasks to calculate how much time they have left for a specific segment of a meeting.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 shows an example of a system for implementing aspects of the present disclosure.

FIG. 2 shows an example UI for selecting a subset of participants from a plurality of participants of a meeting.

FIG. 3A shows a user interface of a group timer at a time near the start of the timer duration.

FIG. 3B shows a user interface of a group timer at a time near the middle of the timer duration.

FIG. 3C shows a user interface of a group timer at a third time near the end of the timer duration.

FIG. 3D shows a user interface of a group timer at the end of the timer duration.

FIG. 4A shows a user interface that allows a user to transition from a display of a communication application to an operating system environment.

FIG. 4B shows an operating system environment having a group timer integrated into a user interface of an application where the group timer is at a time near the start of the timer duration.

FIG. 4C shows an operating system environment having a group timer integrated into a user interface of an application where the group timer is at a time near the middle of the timer duration.

FIG. 4D shows an operating system environment having a group timer integrated into a user interface of an application where the group timer is at the end of the timer duration.

FIG. 5A shows an operating system environment having a group timer integrated into a user interface of an application with an animation where the group timer is at a start time.

FIG. 5B shows an operating system environment having a group timer integrated into a user interface of an application with an animation where the group timer is at a time near the start of the timer duration.

FIG. 5C shows an operating system environment having a group timer integrated into a user interface of an application with an animation where the group timer is at a time near the end of the timer duration.

FIG. 5D shows an operating system environment having a group timer integrated into a user interface of an application with an animation where the group timer is at the end of the timer duration.

FIG. 6A shows an operating system environment having a group timer integrated into a user interface of an application showing a first animation scene indicating that the group timer is at a first time.

FIG. 6B shows an operating system environment having a group timer integrated into a user interface of an application showing a second animation scene indicating that the group timer is at a second time.

FIG. 6C shows an operating system environment having a group timer integrated into a user interface of an application showing a third animation scene indicating that the group timer is at a third time.

FIG. 6D shows an operating system environment having a group timer integrated into a user interface of an application showing a fourth animation scene indicating that the group timer is at a fourth time.

FIG. 6E shows an operating system environment having a group timer integrated into a user interface of an application showing a fifth animation scene indicating that the group timer is at a fifth time.

FIG. 6F shows an operating system environment having a group timer integrated into a user interface of an application showing a sixth animation scene indicating that the group timer is at a sixth time.

FIG. 6G shows an operating system environment having a group timer integrated into a user interface of an application showing a seventh animation scene indicating that the group timer is at a seventh time.

FIG. 6H shows an operating system environment having a group timer integrated into a user interface of an application showing an eighth animation scene indicating that the group timer is at an eighth time.

FIG. 6I shows an operating system environment having a group timer integrated into a user interface of an application showing a ninth animation scene indicating that the group timer is at a ninth time.

FIG. 6J shows an operating system environment having a group timer integrated into a user interface of an application showing a tenth animation scene indicating that the group timer is at a tenth time.

FIG. 6K shows an operating system environment having a group timer integrated into a user interface of an application showing an eleventh animation scene indicating that the group timer is at an eleventh time.

FIG. 7 is a flow diagram showing aspects of a routine for implementing aspects of the disclosed techniques.

FIG. 8 is a diagram illustrating a distributed computing environment capable of implementing aspects of the techniques and technologies presented herein.

FIG. 9 is a computer architecture diagram illustrating a computing device architecture for a computing device capable of implementing aspects of the techniques and technologies presented herein.

### DETAILED DESCRIPTION

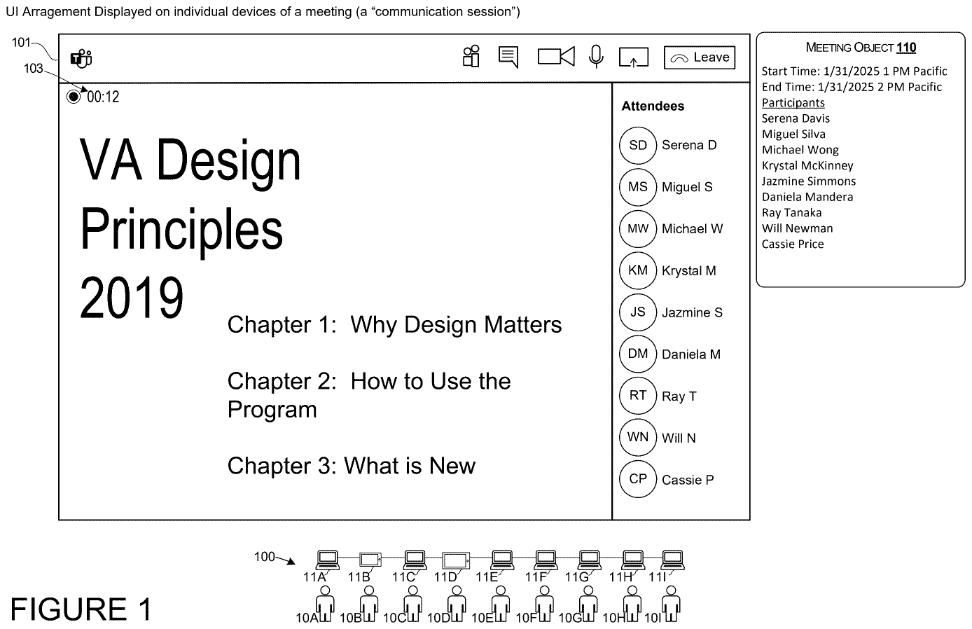

FIG. 1 illustrates a system 100 for providing enhanced controls for sensory group timers. For illustrative purposes, the system 100 includes a number of computing devices 11A-11I (“computers” or “devices”) each associated with individual participants 10A-101 of a communication session. The communication session can include an online meeting, a broadcast, etc. The computers are each connected to a network and the computers are configured to share video signals, audio signals, and other shared content such as documents, and text messages.

To illustrate examples of the sensory group timers, the following description includes scenarios involving nine meeting participants 10A-10I, each using their own devices 11A-11I in a meeting: User A 10A, Serena Davis, is associated with a first computing device 11A, User B 10B, Miguel Silva, is associated with a second computing device 11B, User C 10C, Michael Wong, is associated with a third computing device 11C, User D 10D, Krystal Mckinney, is associated with a fourth computing device 11D, User E, Jazmine Simmons, is associated with a fifth computing device 11E, User F 10F, Daniela Mandera, is associated with a sixth computing device 11F, User G 10G, Ray Tanaka, is associated with a seventh computing device 11G, and User H 10H, Will Newman, is associated with an eighth computing device 11H, and User I 10I, Cassie Price, is associated with a ninth computing device 11I. Although this example shows a scenario with nine computers, it can be appreciated that the system can operate with any other number of computers, including other types of computers such as a server, and the system can involve any number of participants.

Also shown in FIG. 1, each device 11 of each participant 10 displays a user interface 101 that includes a rendering of shared content. In this example, one participant is sharing a slide with other participants. This display is shared across all participants, and when a presenter makes a change to the user interface, the user interface 101 changes for all participants. The user interface also includes a meeting timer 103 that is displayed to all participants. The meeting timer 103 shows an elapsed time that starts when a participant first initiates the meeting, and this timer runs continuously until the meeting ends. As will be described in more detail below, the meeting timer 103 is different than, and separate from, a sensory group timer, which is only displayed to a subset of the participants.

When a meeting is configured, the system generates a meeting object 110. The meeting object 110 can be updated by a designated user, such as an organizer. When the organizer adds names and roles of each meeting participant, the system updates the meeting object 110 with the participants' identity and corresponding roles. The corresponding roles also define permissions for each user. For example, the meeting object 110 can define permissions that allow presenters to share video and audio streams with the other participants. The meeting object 110 can also define a start time and end time for the meeting.

The meeting object 110 is also used to store permissions that define subsets of participants for allowing each subset of participants to share a group timer. When the system receives an input identifying a selection of a subset of participants for managing the group timer, the system updates the meeting object 110 to identify the participants that are members of a subset (“subgroups”). Individual subsets can be developed for different purposes, for example, one group of presenters maybe associated with one subset to manage a group timer. The system can manage any number of subgroups, where each subgroup is associated with an independently managed group timer. Each subgroup can manage the start time and stop time of their own group timer, and the permissions of the meeting object only allow members of a specific subset of participants to view the group timer for that specific subset of participants.

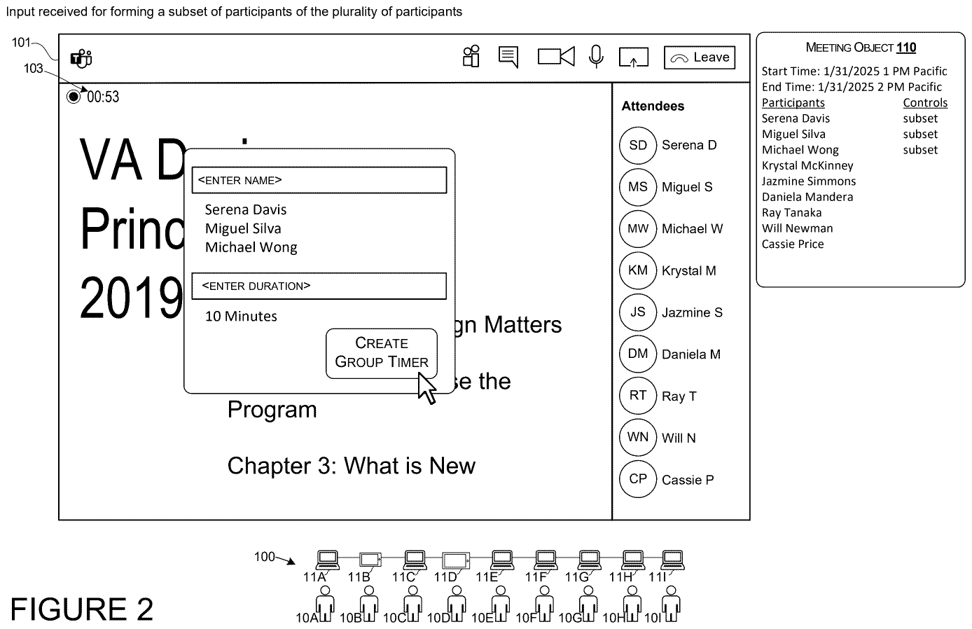

FIG. 2 shows one example user interface that may be used for receiving a selection of the subset of participants for managing the group timer shared only within the subset of participants. As shown, a UI can be displayed that allows a participant to select names of meeting participants for creating a subgroup to share a group timer. Upon selection of the subset of participants, the system configures the meeting object 110 with the selection of identities. The system can also associate special permissions for the subset of participants. The special permissions can cause the system to restrict the display of a particular group timer to one subset of devices of the subset of participants. Also shown in FIG. 2, the UI can enable the receipt of a duration for a particular group timer.

For illustrative purposes, the example shown in FIG. 2 shows a selection of three participants 10A-10C who are selected to be members of a subset for a group timer. In response to receiving the identities of the select participants, the system configures the meeting object 111 with permissions for controlling a display of a group timer. The permissions allow the group timer to be displayed on the devices 11A-11C of the subset of participants 10A-10C. The permissions are also configured to restrict or prevent the group timer for this subset of participants 10A-10C from being displayed on the other devices 11D-11I of other participants 10D-10I that are not part of the subset of participants 10A-10C. Also shown, in this example, a duration for this particular group timer is set to 10 minutes.

The permissions are configured to allow the devices 11A-11C of the subset of participants 10A-10C to maintain video and audio communication with the other devices 11D-11I of the other participants while the group timer is exclusively displayed on the devices 11A-11C of the subset of participants 10A-10C. Thus, even though the display of the group timer is limited to a subset of devices 11A-11C, the entire set of participants 10A-101, e.g., User A through User I, remain in the same communication mode even. Thus, the status of the group timer, e.g., whether the group timer has started, is paused or has stopped, does not cause a change in the UI or devices of the other participants 10D-10I. This provides privacy to the subset of participants since the other participants 10D-10I are not notified of the existence or status of the group timer. In addition, the other participants 10D-10I are not distracted by the display of the group timer.

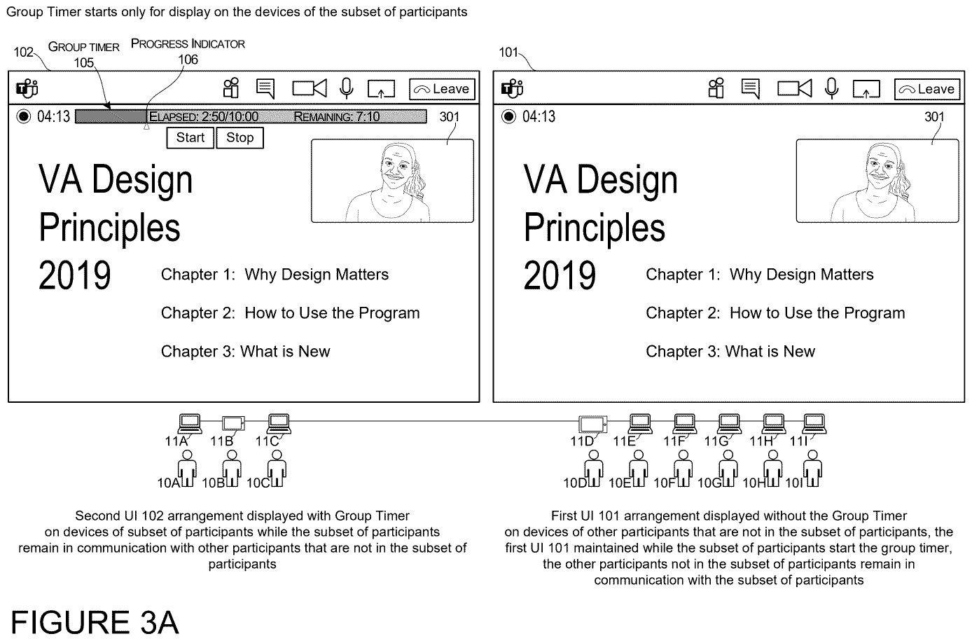

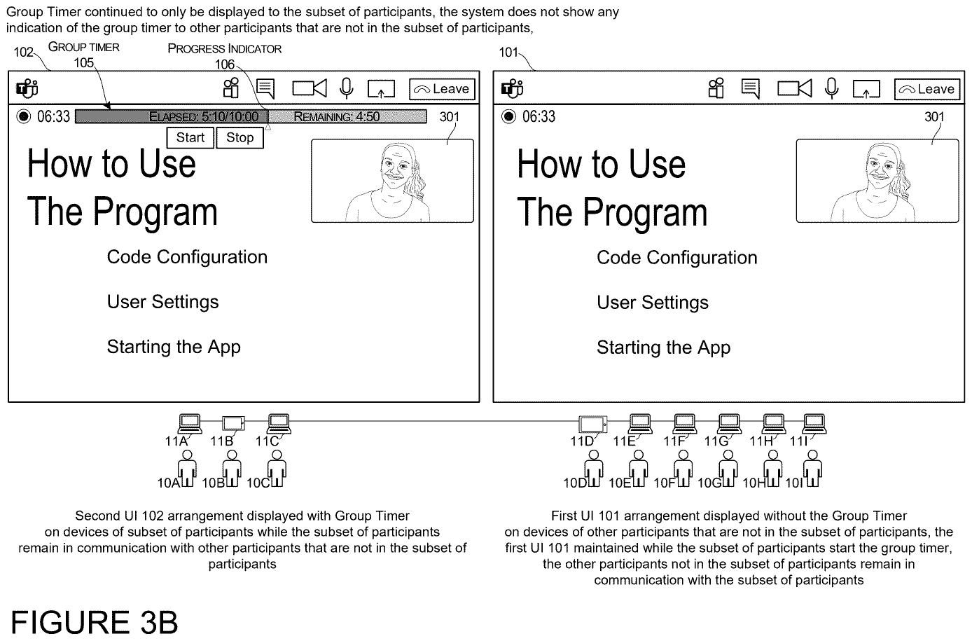

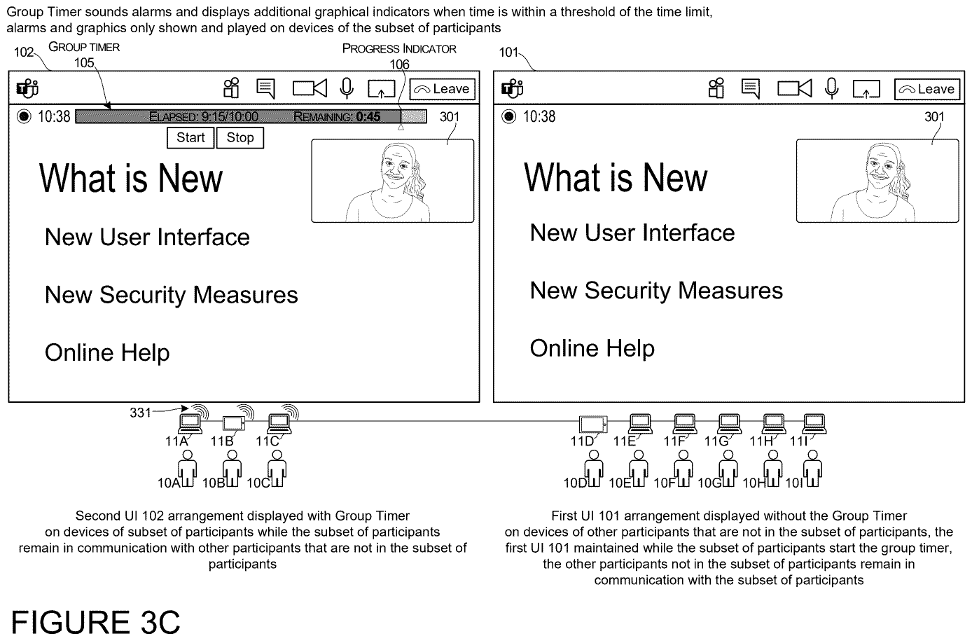

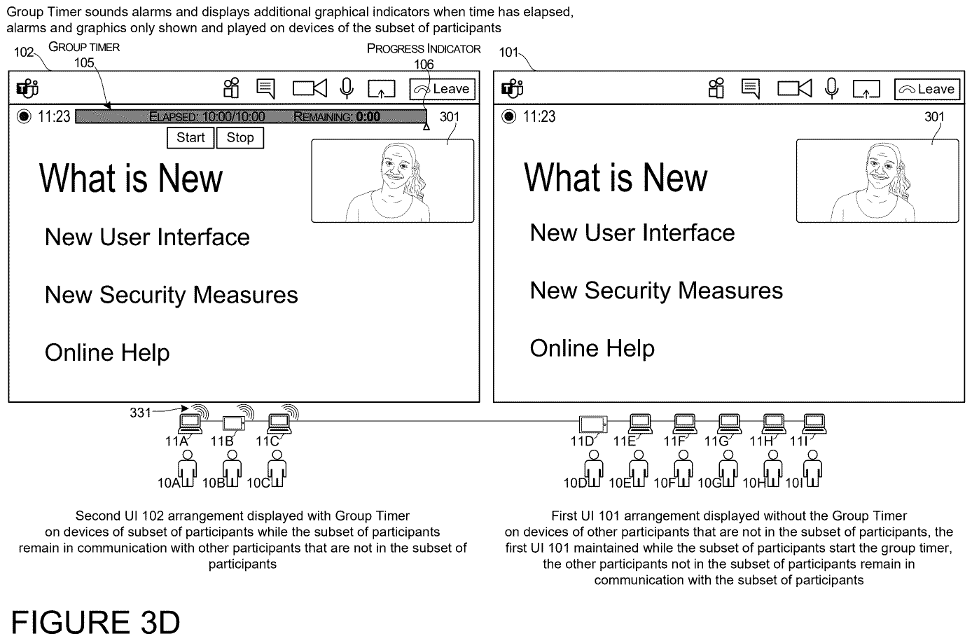

Referring now to FIGS. 3A-3D, techniques for controlling the display of a group timer are shown and described below. As shown on the left side of FIG. 3A, the system uses the permissions of the meeting object to cause a display of a user interface 102 comprising the rendering of a group timer 105 on the devices 11A-11C of the subset of participants 10A-10C. As shown on the right side of FIG. 3A, the system uses the permissions of the meeting object to restrict the rendering of the group timer from being displayed on the other devices 11D-11I of the other participants that are not part of the subset of participants 10A-10C. For illustrative purposes, the user interface arrangement 101 shown on the right is also referred to herein as a “first user interface arrangement 101.” This first user interface arrangement 101 is displayed to the other devices 11D-11I of the other participants before, during, and after the creation and operation of the group timer. In addition, this first user interface arrangement 101 is also displayed to the entire set of participants before the group timer is created by the subset of users. The other user interface 102 displaying the group timer to the subset of devices 11A-11C is also referred to herein as a “second user interface arrangement 102.”

Also shown in FIG. 3A, the permissions cause the system to maintain the same mode of communication between all participants 10A-10C even when the timer is created and/or displayed to the subset of users. This means that the status or creation of the group timer does not change a status of any communication between the meeting devices. Thus, when the group timer is created or displayed, the devices 11A-11I of the entire set of participants 10A-10I maintain at least one of modes of communication that existed prior to the creation or display of the group timer, where the modes include video communication, audio communication, file sharing, etc. This feature includes operations for maintaining communication between the devices 11A-11C of the subset of participants 10A-10C and other devices 11D-11I of the other participants 10D-10I while the group timer is displayed only on the devices 11A-11C of the subset of participants 10A-10C.

Also shown in FIGS. 3A-3D, the group timer includes a graphical element in the form of a progress bar showing a start time and end time. In addition, the group timer can include a progress indicator 106 showing the elapsed time and the remaining time. In any of the embodiments disclosed herein, a group timer can be started by any of the members of the subset. In some embodiments, the system restricts other users outside the subset from controlling or viewing the group timer. A group timer can be started by an input at a user interface, a voice command, or by the use of any other suitable input gesture captured by an input device, such as a touchpad or a camera directed to one of the members of the subset.

As shown in the progression between FIGS. 3A, 3B, 3C, and 3D, after the timer starts, the graphical element can include an animation showing the progress of the group timer. As shown in FIG. 3C, the devices 11A-11C of the subset can sound audible alarms 331 and display additional graphical indicators, such as bold text or other graphics with a progress indicator 106 when the elapsed time is within a threshold of the end time. As shown in FIG. 3D, the devices 11A-11C of the subset can sound additional audible alarms 331 and display other graphical indicators, such as bold text or other graphics with the progress indicator 106 when the elapsed time has reached the end time.

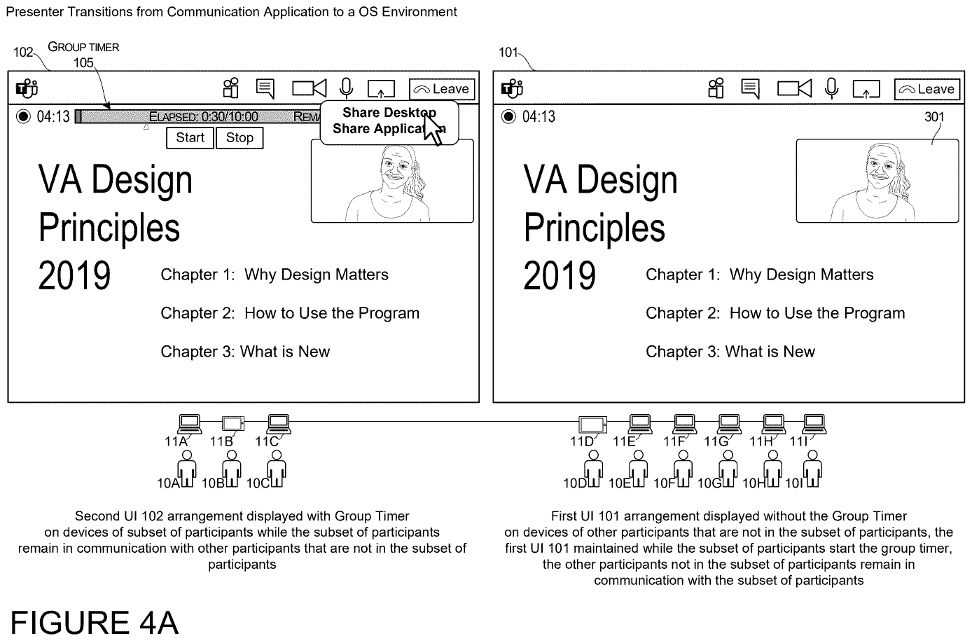

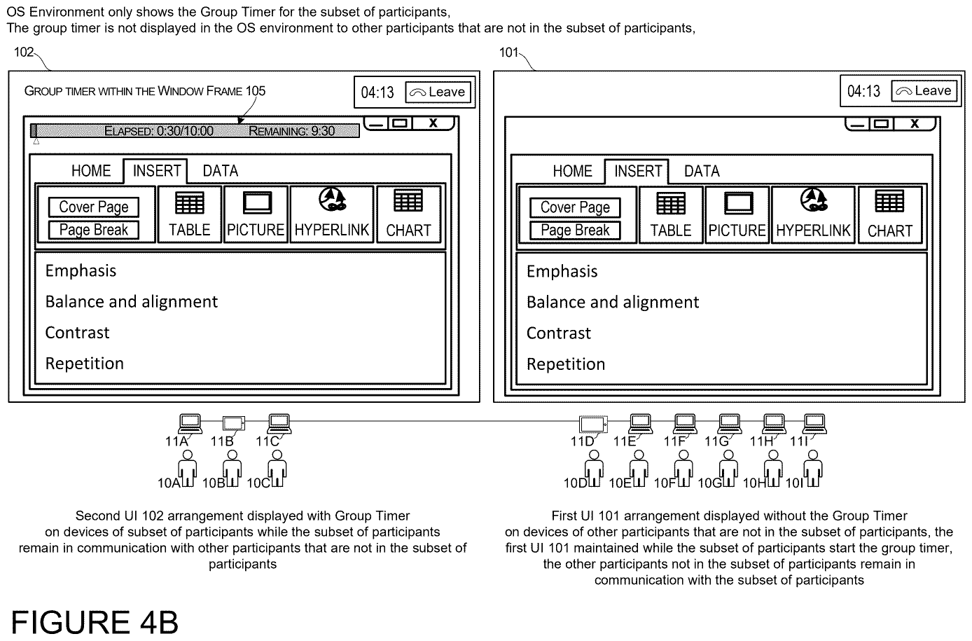

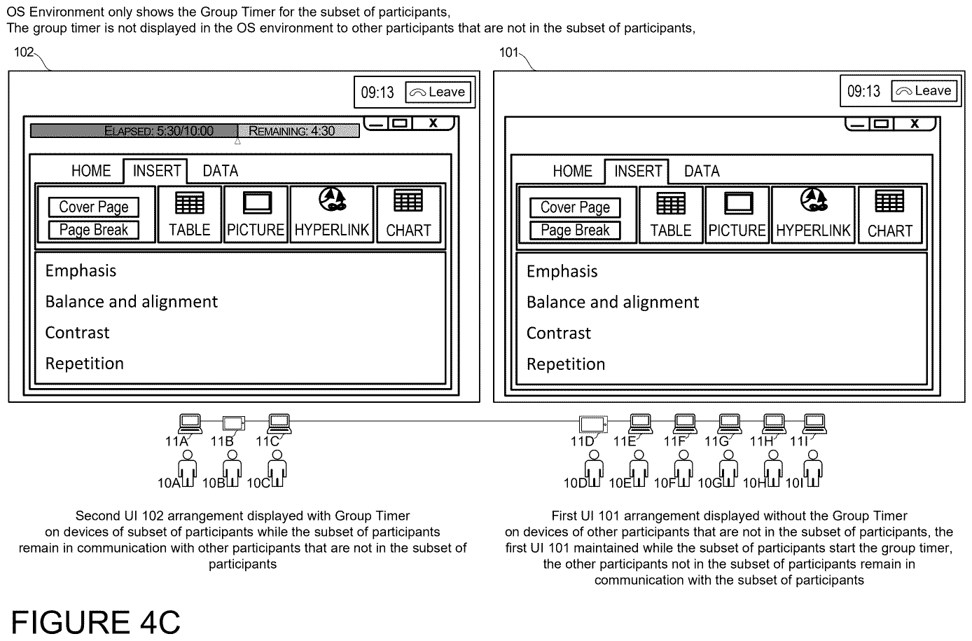

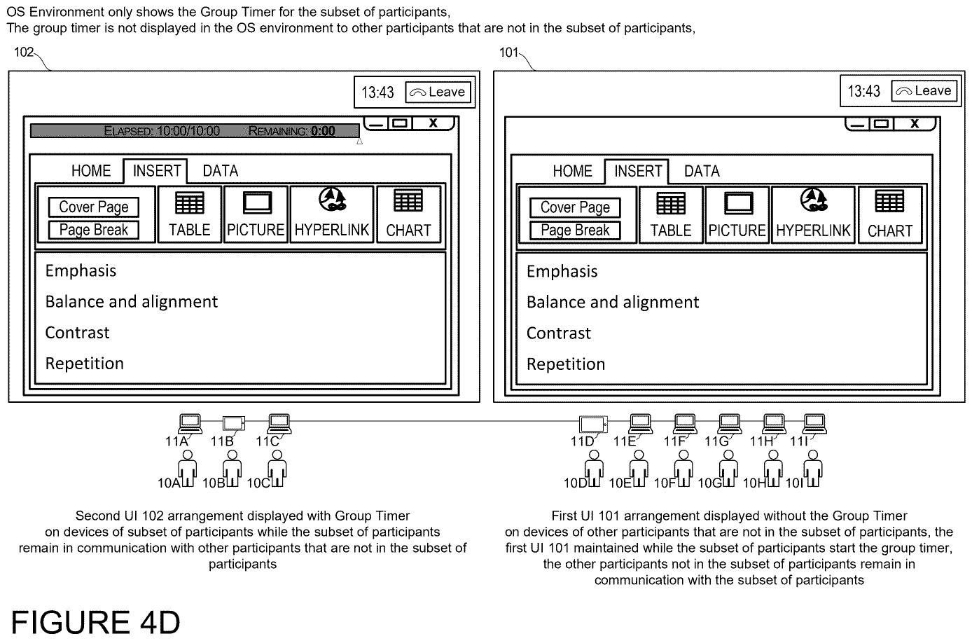

Referring now to FIGS. 4A-4D, an embodiment of a group timer displayed in a user interface of a separate application is shown and described below. In this example, after the selection of a subset, one user of the subset may initiate a control that causes a presentation to switch from a screen share within a communication application (e.g., MS TEAMS, GOOGLE MEET, SLACK, etc.) to a screen share of an application rendered in an operating system environment. The application can include applications such as Word, Excel, PowerPoint, etc.

FIG. 4A shows a user interface that allows a user to transition from a shared display of a communication application to an operating system environment. As shown, the system can receive an input from at least one participant of the subset of participants to share a user interface showing a selected application executing in the operating system environment. Then, as shown in FIG. 4B, in response to input, the system shows another version of the second user interface arrangement 102 on the devices 11A-11C of the subset of users 10A-10C. This version of the second user interface arrangement 102 includes a view of a rendered application in a desktop environment. The second user interface arrangement 102 also shows the group timer 105 with a display of the meeting timer and other UI elements for controlling aspects of the communication session, e.g., a leave button. Using the permissions of the meeting object, the system restricts this second user interface arrangement 102 from being displayed on the other devices 11D-11I of the other users 10D-10I that are not part of the subset.

The user interface arrangement 101 that is displayed on the other devices 11D-11I of the other users 10D-10I shows the same shared content, e.g., the application shared by the presenter, that is displayed in the second user interface 102. However, the first user interface arrangement 101 displayed on the other devices 11D-11I of the other users 10D-10I does not display the group timer 105, nor does it display any indication of the existence or status of the group timer.

In this example, the group timer 105 is the form of a progress bar embedded in the frame of the user interface of the application. In some embodiments, the system can display the elapsed time and the remaining time. The size, color and position of the graphical representation of the group timer is designed to be noticeable to the presenters but not sized to unnecessarily monopolize screen space or cause distractions to the presenters.

As shown in the transition between FIGS. 4B, 4C and 4D, after the timer has started, the progress bar moves a graphical element in the progress bar and the progress indicator until the group timer reaches the end time of the designated duration, at which at that time additional graphics, an audible alarm, or haptic feedback can be generated at the subset of devices 11A-11C.

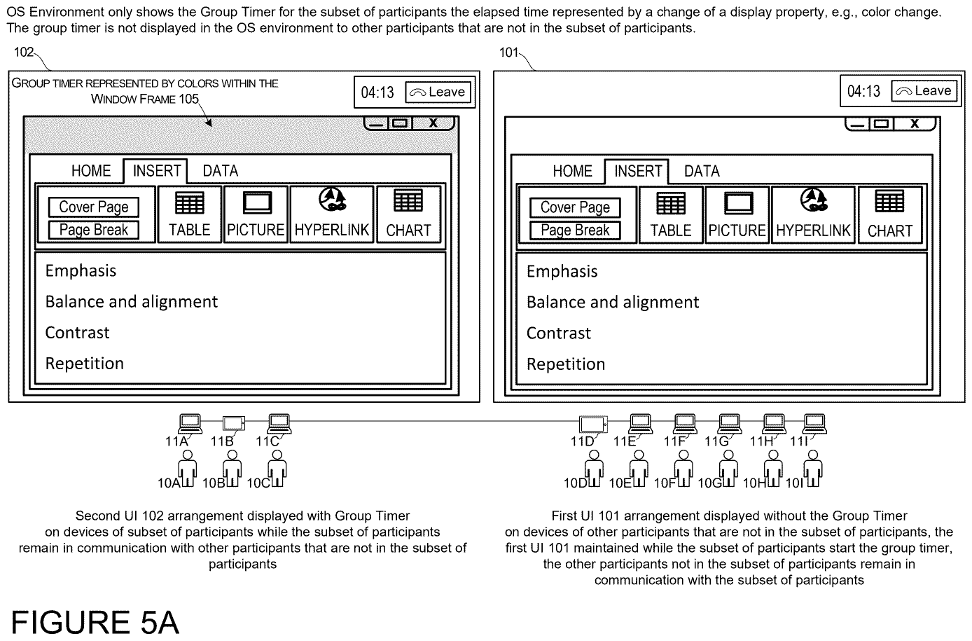

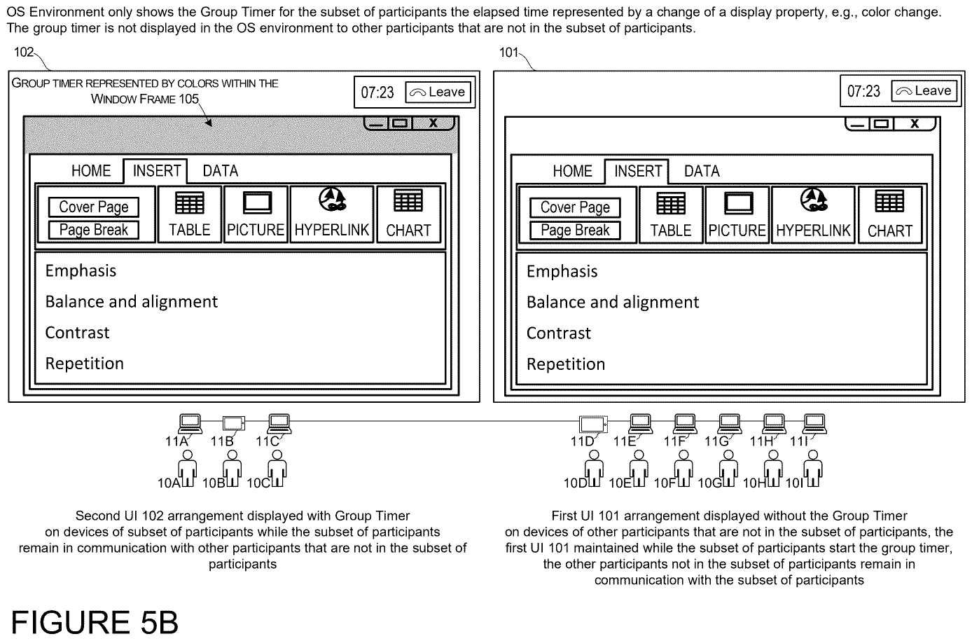

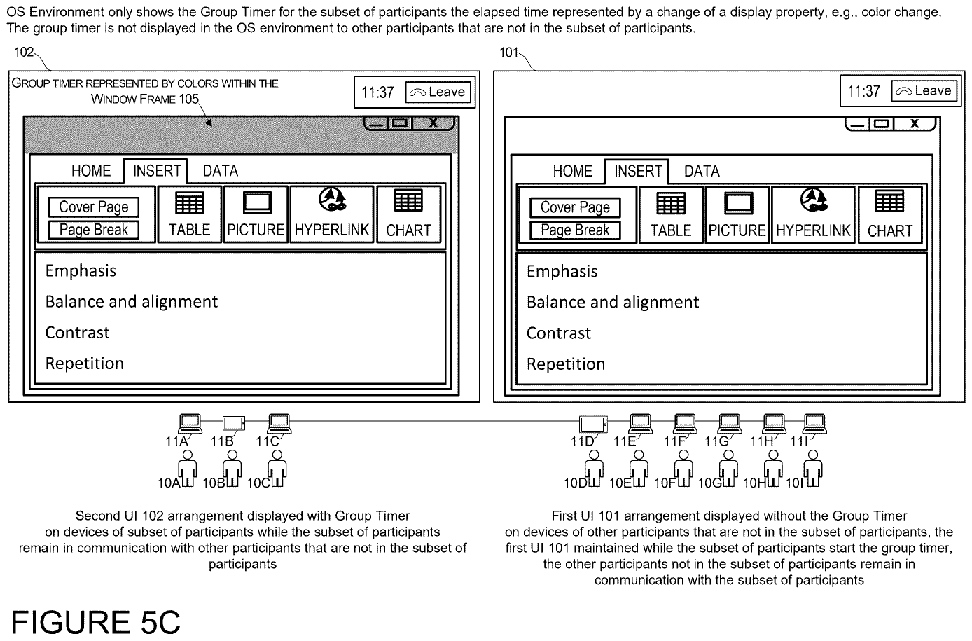

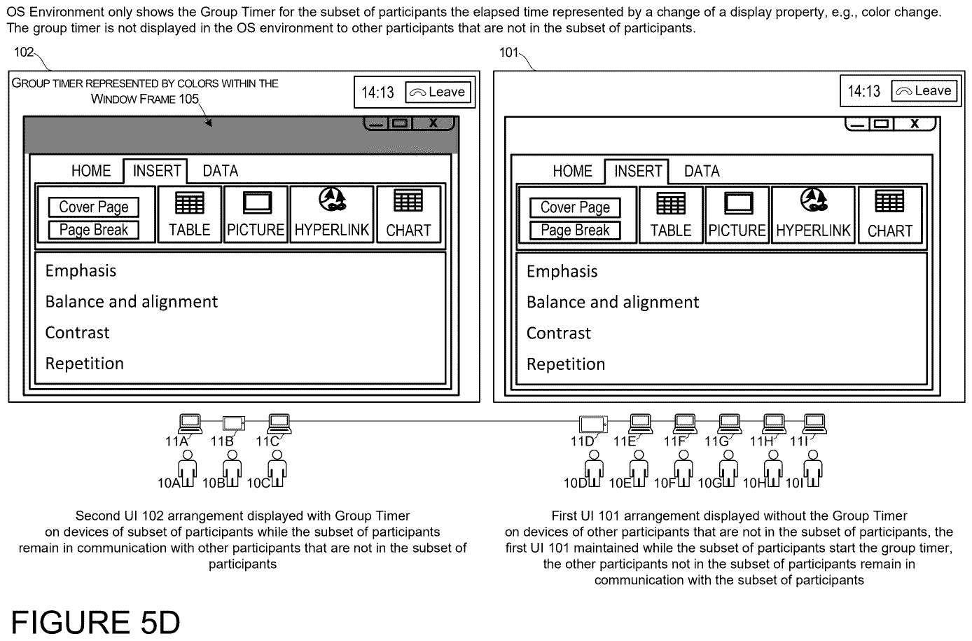

Referring now to FIGS. 5A-5D, another embodiment of a group timer is shown and described below. In this embodiment, the group timer provides sensory accommodations that include customizations to visual notifications, sounds, and haptics that are less distracting than timers having traditional visualizations. In this example, a system can cause changes to display properties in the frame of a user interface. These changes to the display properties can include changes to colors, shapes, brightness or other visualizations that indicate the progress of a group timer. These changes to the display properties are applied in a manner as described above, e.g., the visualizations are only displayed on the devices of the subset of participants. The other participants that are not in the subset only view the shared application without the changes to the display properties showing the progress of the group timer.

One illustrative example of customized visualizations is shown in the transitions between the drawings of FIGS. 5A-5D. These transitions can include a color transition or a brightness transition from a first color and/or brightness level representing the start of the duration of the group timer to a second color and/or brightness level representing the end of the duration of the group timer. Specific to the example starting at FIG. 5A, the color of the UI frame starts at a light color and brightness level representing the start of the duration of the group timer. Then, as the group timer progresses, the color and brightness level at each stage progressively transition to a darker color, eventually ending at the end of the timer duration shown in FIG. 5D, where additional notifications can be generated at each of the devices 11A-11C. The progress of the group timer can be displayed with a counter showing the elapsed time and/or remaining time of the group timer.

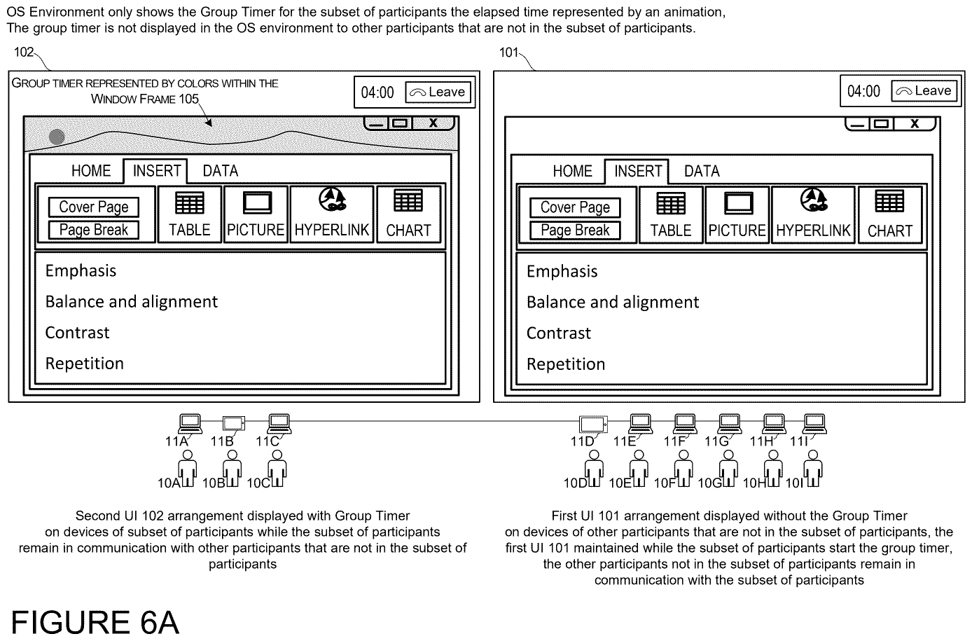

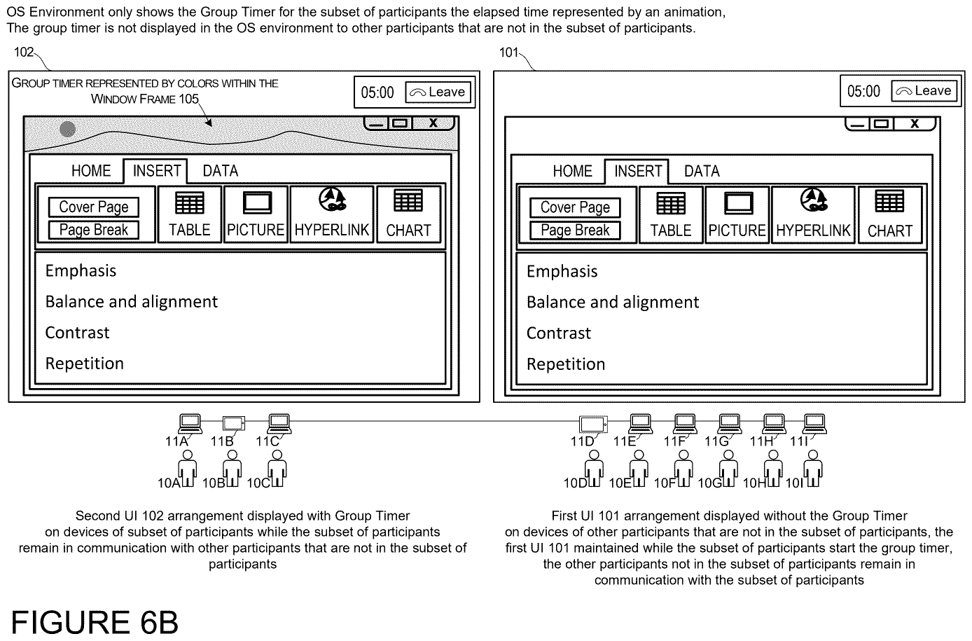

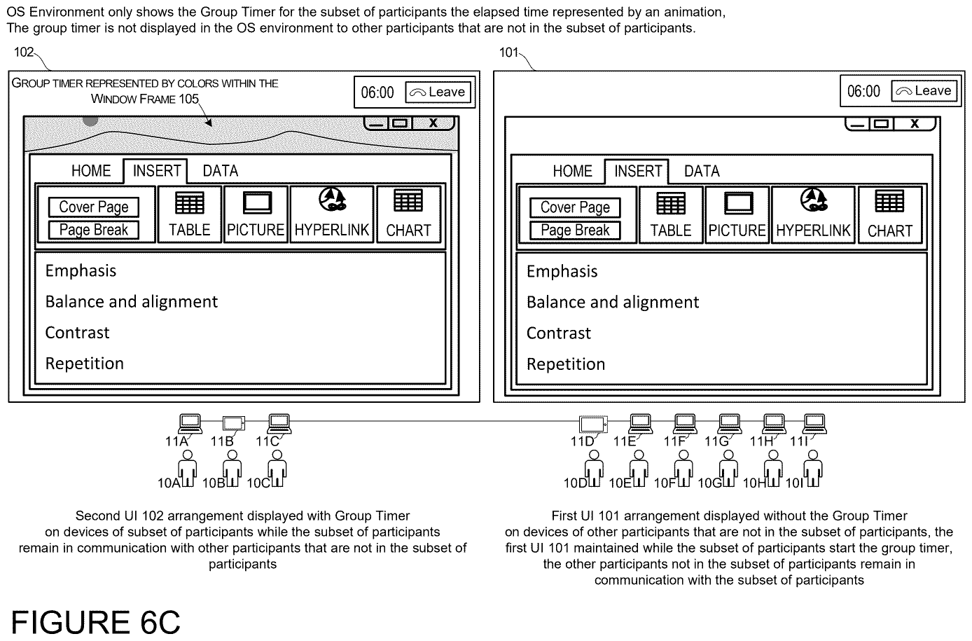

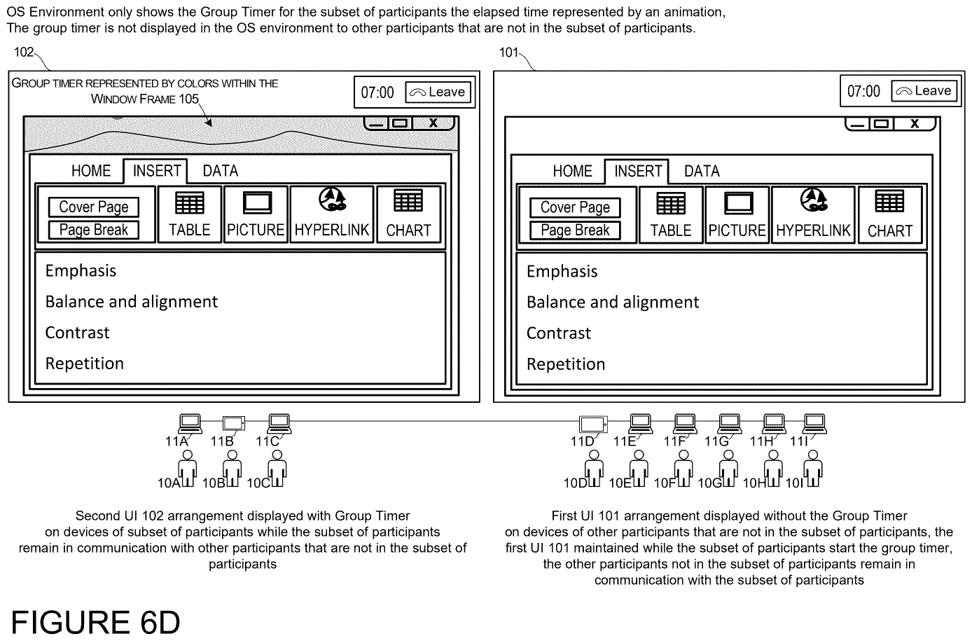

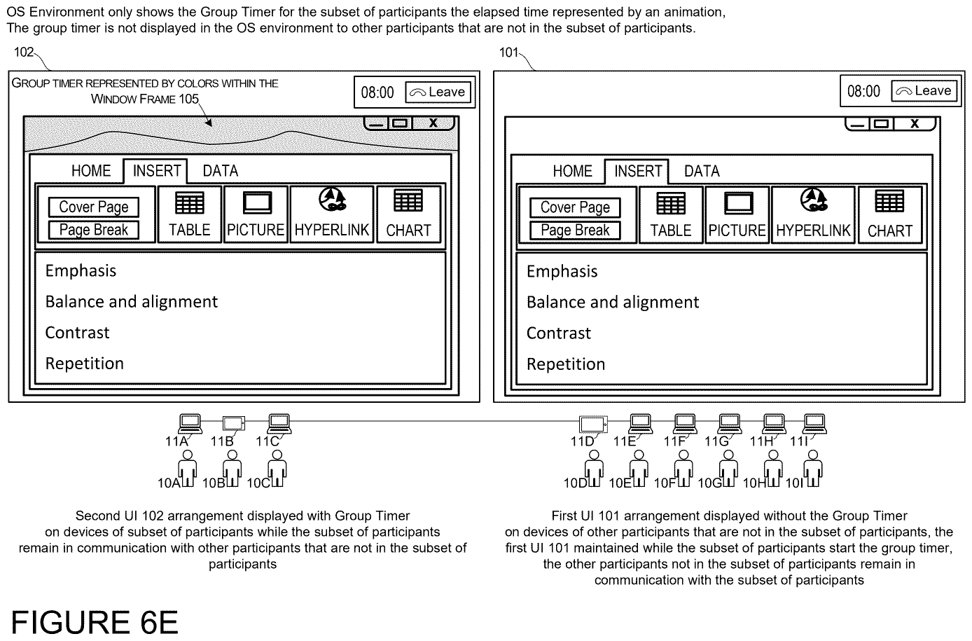

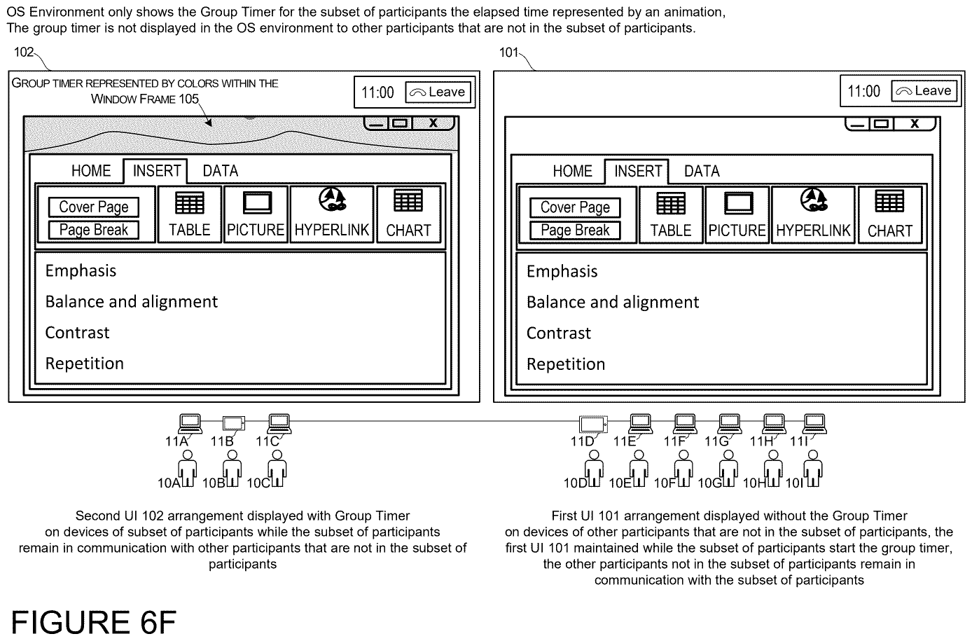

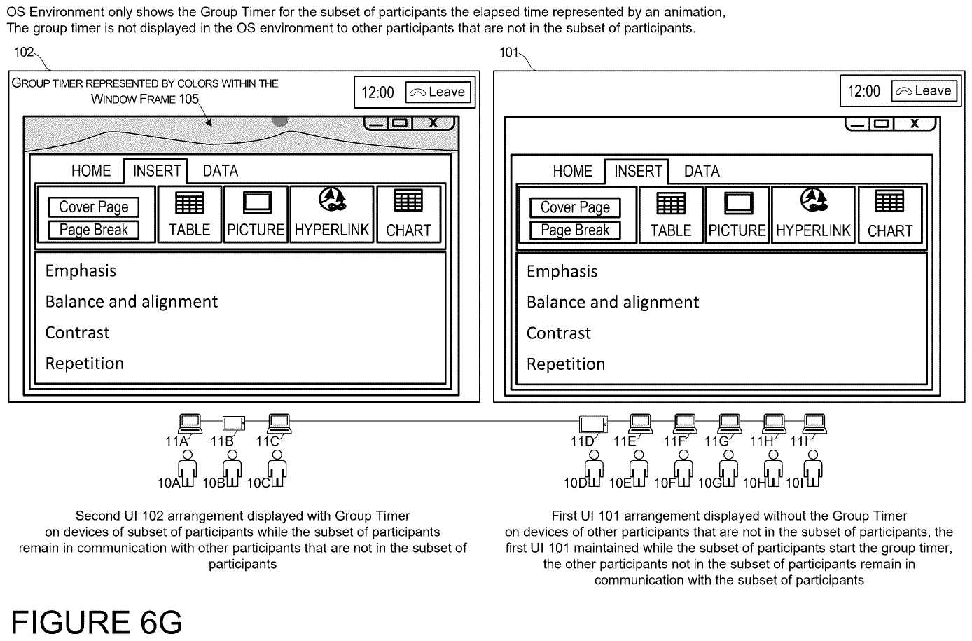

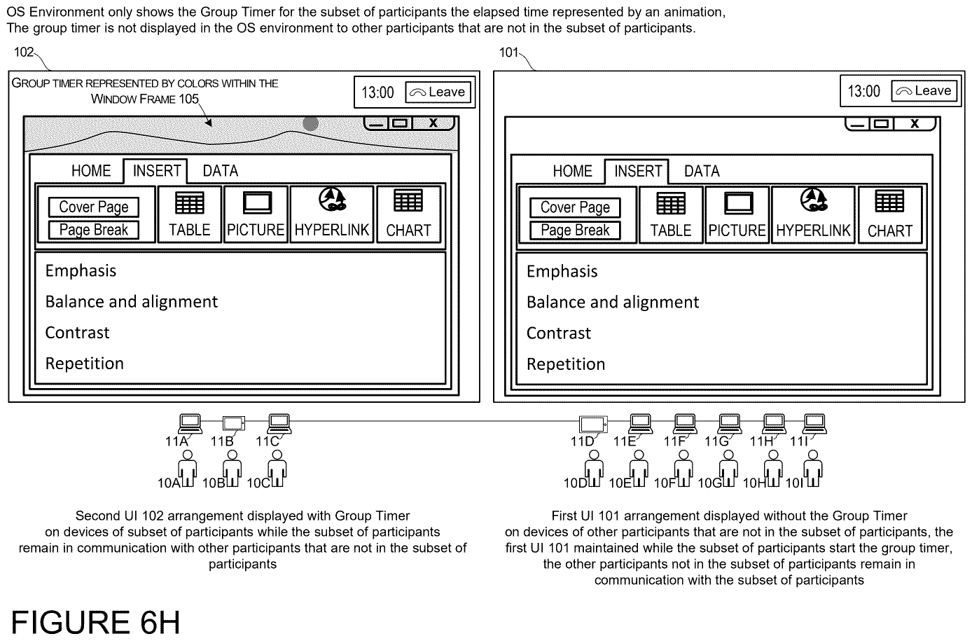

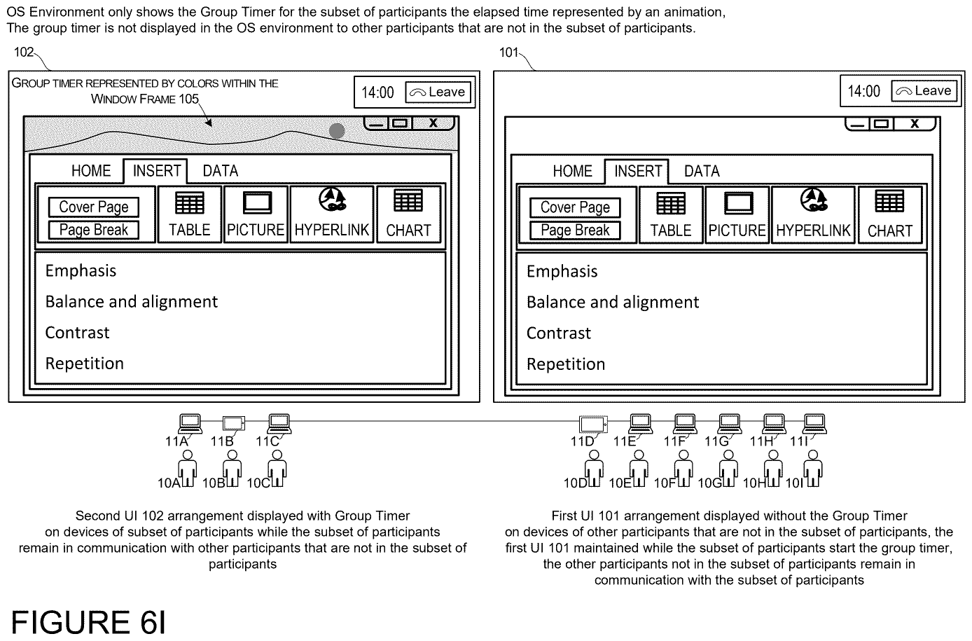

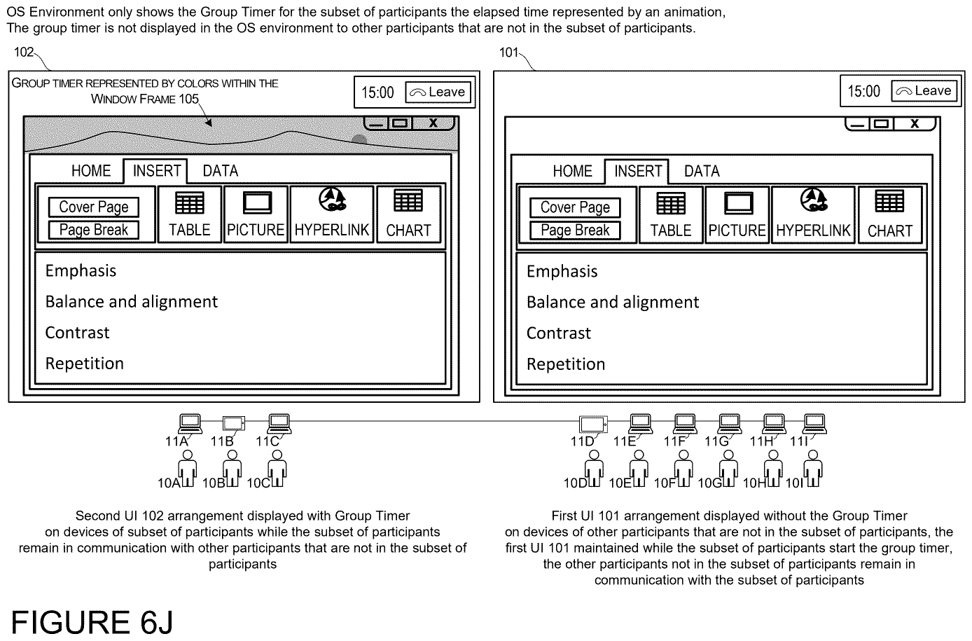

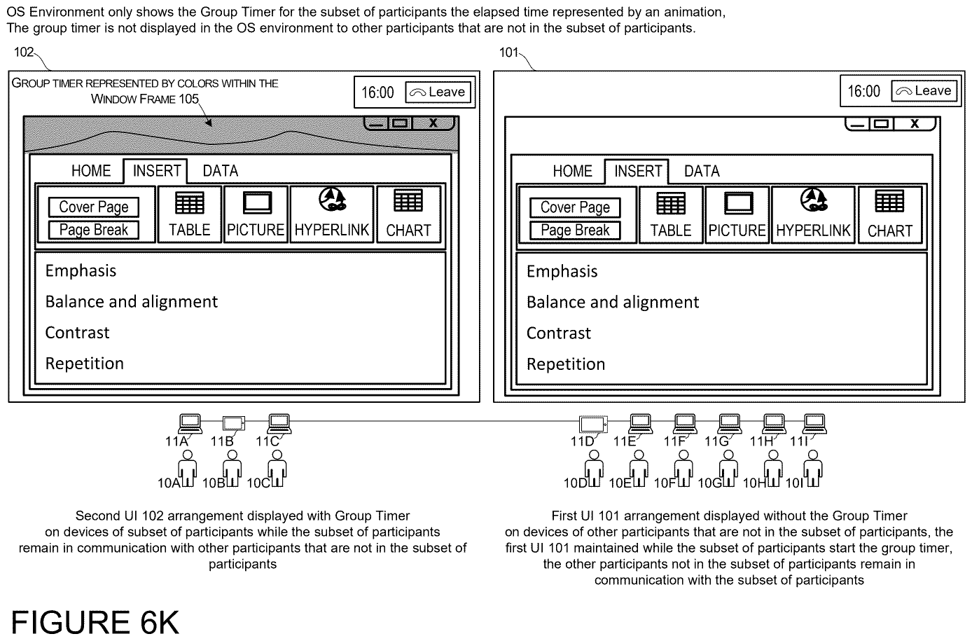

Referring now to FIGS. 6A-6K, an embodiment of a group timer that is displayed as an animation is shown and described below. This is an example where animations are integrated into the frame of the user interface. This example shows an animation that depicts the progress of a group timer without the use of intrusive notifications that unnecessarily use a large portion of a screen. As shown in the transitions between FIGS. 6A through 6K, the animation shows a sunrise to represent the start of the time period and a sunset to represent the end of the time period. Such animations can be coordinated with subtle sounds and haptics to provide notifications to specific participants.

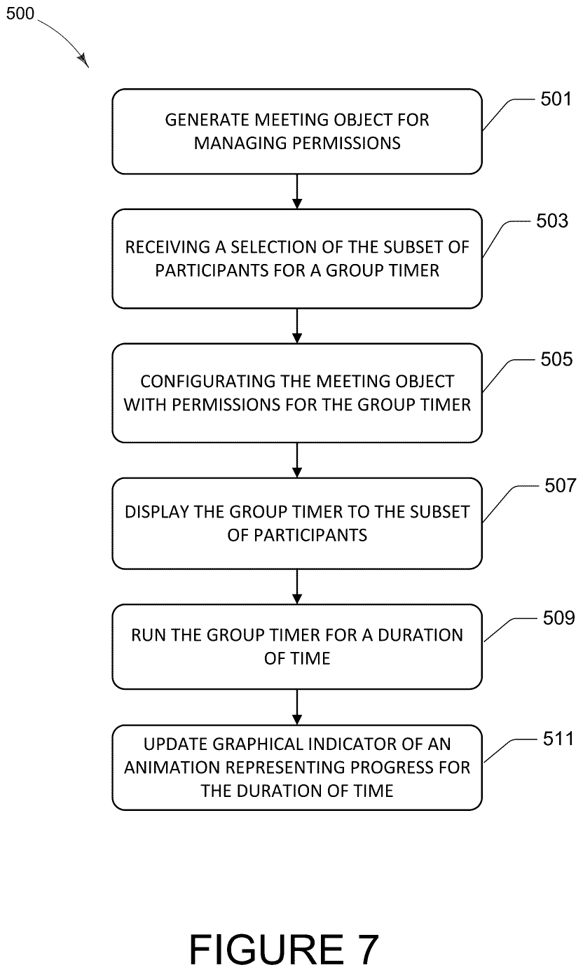

Turning now to FIG. 7, the following section describes aspects of a routine 500 for providing enhanced controls for sensory group timers is shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following description refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine 500 starts at operation 501, where the system generates a meeting object for managing permissions. As shown in FIG. 1, the system includes the storage of a data structure for storing a meeting object that is used to manage a meeting. This includes generating a meeting object for managing permissions of the plurality of participants of the meeting. The meeting object 111 further defines the start time of the meeting and an end time of the meeting, the meeting object 111 also defines permissions for maintaining the communication of audio streams and video streams between the plurality of participants 10A-10I while the group timer is displayed to one specific subset of devices.

At operation 503, the system receives a selection of the subset of participants for a group timer. This operation can include receiving a selection of the subset of participants 10A-10C for managing the group timer shared only within the subset of participants 10A-10C. As shown in FIG. 2, the system allows a user to designate a subgroup comprising a subset of the conference attendees such as a subset of attendees making a presentation in the meeting or a “confidential” subgroup in an online negotiation meeting.

At operation 505, the system configures the meeting object with permissions for the group timer using the input defining the selection of the subset of participants 10A-10C for managing the group timer. Also shown in FIG. 2, this includes creating a subgroup timer to be shared only within the designated subset group in the online meeting including all attendees. Operation 505 can include configurating the meeting object with permissions for controlling the display of a rendering of the group timer, the permissions allowing the rendering of the group timer to be displayed on the devices 11A-11C of the subset of participants 10A-10C. The permissions can be set to restrict the rendering of the group timer from being displayed on the other devices 11D-11I of the other participants that are not part of the subset of participants 10A-10C.

At operation 507, the system can display the group timer to the subset of participants. For example, as shown in FIGS. 3A-3D, the system can display a group timer to be shared only within a subset of devices of a subset of participants. This can include using the meeting object to cause a display of a user interface comprising the rendering of the group timer on the devices 11A-11C of the subset of participants 10A-10C. The permissions can restrict the user interface comprising the rendering of the group timer from being displayed on the other devices 11D-11I of the other participants that are not part of the subset of participants 10A-10C.

At operation 509, the system can run the group timer for a duration of time that is defined by a user input. The timer can be started by an input from any user of the subset, e.g., using a voice command or selecting a menu item on a user interface.

At operation 511, the system can update graphical indicator of an animation representing progress of the group timer. The system can also generate a visual notification or a sound when the duration has elapsed or when the timer is within a threshold time from the end of the duration. Updates to the graphical indicator can also include periodic updates to a user interface having an animation that shows the progress of a group timer.

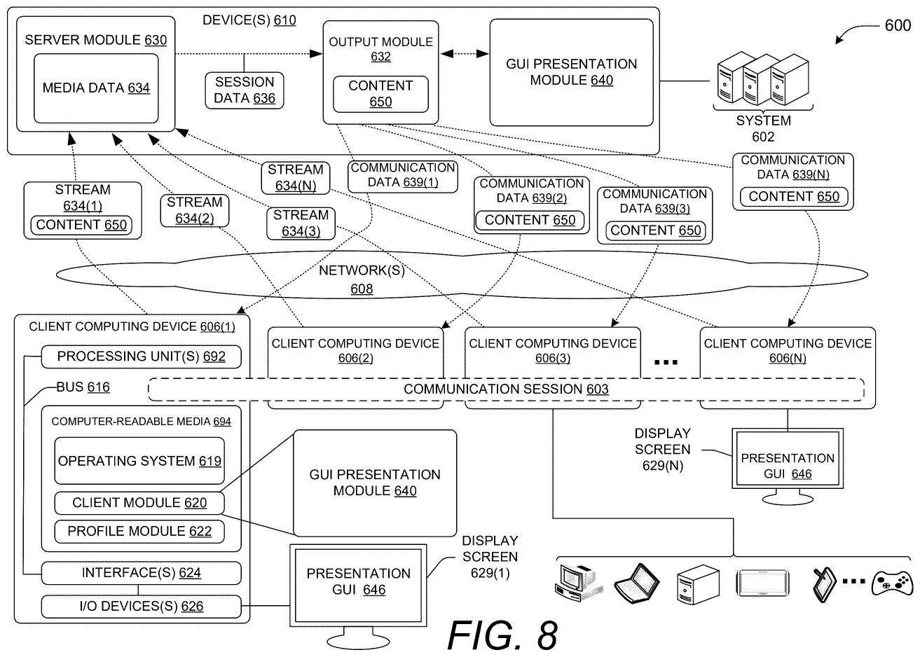

Turning now to FIG. 8, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603. A communication session 603 can include a call, which can be a direct call from a person to others, a communication session 603 can also include a meeting, which is an appointment that is established by a calendar event defining attendees.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 8 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a vocal input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 8 illustrates that client computing device 606(1) is in some way connected to a display device (e.g., a display screen 629(N)), which can display a UI according to the techniques described herein.

In the example environment 600 of FIG. 8, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 8) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 8, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

FIG. 9 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which is also referred to herein as computer-readable storage media, a computer-readable medium, or computer-readable storage medium, includes one or more of volatile memory, nonvolatile memory, and/or other persistent and/or auxiliary computer storage media, rotating storage medium such as a disk, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

A “computer-readable storage device” or a “computer-readable device” includes non-transitory computer-readable storage media such as one or more of volatile memory, nonvolatile memory implemented in any method or technology for storage of information such as computer-readable instructions, data structures, program modules, or other data. Thus, a computer-readable storage device includes tangible and/or physical forms of a hardware component that is part of a computing system or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), or flash memory, solid-state memory devices, storage arrays, network attached storage, storage area networks. The computer-readable storage device also includes a physical hardware device having circuitry and magnetic sensors, optical sensors, or other sensors for reading a compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, or any other physical locally stored medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store the primary calendar and secondary calendar, and other session data that show the status and activity level of each user. The session data can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the meeting objects described herein. The session data 714 can also include video, audio, or other content that can be shared in a meeting. The session data can also include permissions for each user. For example, session data can indicate if a person is part of a subset and whether they have permission to display and/or control a group timer.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

The following clauses supplement the present disclosure.
Clause A: A computer-implemented method for controlling a group timer only displayed to a subset of participants 10A-10C of a meeting of a plurality of participants 10A-101, the computer-implemented method for execution on a computing device comprising: generating a meeting object 111 for managing permissions of the plurality of participants of the meeting, the meeting object 111 further defining the start time of the meeting and an end time of the meeting, the meeting object 111 defining permissions controlling communication of audio streams and video streams between the plurality of participants 10A-101; receiving a selection of the subset of participants 10A-10C for managing the group timer shared only within the subset of participants 10A-10C; configurating the meeting object 111 with permissions for controlling a display of the group timer, the permissions allowing the group timer to be displayed on the devices 11A-11C of the subset of participants 10A-10C, the permissions restricting the group timer from being displayed on the other devices 11D-11I of other participants 10D-10I that are not part of the subset of participants 10A-10C, the permissions allowing the devices 11A-11C of the subset of participants 10A-10C to maintain video and audio communication with the other devices 11D-11I of the other participants while the group timer is displayed on the devices 11A-11C of the subset of participants 10A-10C; and using the permissions of the meeting object to cause a display of a user interface 102 comprising the rendering of the group timer on the devices 11A-11C of the subset of participants 10A-10C, the permissions restricting the user interface comprising the rendering of the group timer from being displayed on the other devices 11D-11I of the other participants that are not part of the subset of participants 10A-10C, wherein the permissions cause the system to maintain at least one of the video communication and the audio communication between the devices 11A-11C of the subset of participants 10A-10C and other devices 11D-11I of the other participants 10D-10I while the group timer is displayed only on the devices 11A-11C of the subset of participants 10A-10C.
Clause B: The computer-implemented method of Clause A, wherein the user interface 102 is a second user interface 102, wherein the method further comprises: causing a display of a first user interface 101 comprising a meeting timer that is independently run from the group timer, the first user interface 101 comprising at least one of a video stream or an image shared between a plurality of devices 11A-11I of the plurality of participants 10A-101, wherein the first user interface 101 is displayed prior to the display of the second user interface 102; and transitioning the display of the first user interface 101 on the devices 11A-11C of the subset of participants 10A-10C by replacing the first user interface 101 with the second user interface having the group timer on the devices 11A-11C of the subset of participants 10A-10C, wherein the transition of the first user interface 101 is performed while the first user interface 101 is maintained on the other devices 11D-11I of the other participants that are not part of the subset of participants 10A-10C without providing an indication of the group timer to the other participants.
Clause C: The computer-implemented method of Clauses A through B, further comprising: receiving an input indicating a duration of the group timer; configuring the meeting object to store the duration of the group timer, the meeting object further comprising permissions to only permit the subset of participants to edit the duration of the group timer and to start the group timer; receiving an input from one participant of the subset of participants to start the timer; in response to the input to start the timer, starting the group timer and displaying an updated display of at least one of an elapsed time of the group timer or a remaining time of the group timer; determining that the group timer is within a time threshold from the end of the duration or at the end of the duration; and in response to determining that the group timer is within a time threshold from the end of the duration or at the end of the duration, causing an alarm to sound or generating a graphical notification on at least one device of the devices of the subset of participants.
Clause D: The computer-implemented method of Clauses A through C, wherein the permissions are configured to allow the subset of participants to transfer a display of the timer to an application operating in an operating system environment, the computer-implemented method further comprising: receiving an input from at least one participant of the subset of participants to share a user interface of the application operating in the operating system environment; in response to input from at least one participant of the subset of participants to share a user interface of the application operating in the operating system environment: causing one or more devices of the plurality of devices to display the user interface of the application operating in the operating system environment; and causing a display of the rendering of the group timer in conjunction with the display of the user interface of the application operating in the operating system environment.
Clause E: The computer-implemented method of Clauses A through D, further comprising: generating an animation within a frame of the user interface or within a background of a user interface, where in the animation changes display properties that include brightness or color changes, wherein A color or brightness changes to a darker shade indicating that the group timer is approaching the end or at the end of a duration of the timer.
Clause F: The computer-implemented method of Clauses A through E, further comprising: generating an animation representing the progress of the group timer between a start of the group timer up to the end of a duration of the group timer, where the animation transitions through individual scenes, where each transition between individual scenes starts at a first scene illustrating a theme indicating a start time of the group timer and ends at a last scene illustrating a theme indicating a time near an end of a duration of the group timer or at the end of the group timer.
Clause G: The computer-implemented method of Clauses A through F, further comprising: determining milestones and a duration of the group timer, where the milestones have individual time periods, wherein the duration of the group timer and the time periods of the milestones are based on at least one of a user input indicating durations of each milestone or the duration, an analysis of the content a shared filed to determine durations of each milestone, or an analysis of an agenda to determine durations of each milestone; and generating a graphical representation of the group timer showing the milestones and a marker showing a progress of the group timer after the group timer has started, and displaying an updated display of at least one of an elapsed time of the group timer or a remaining time of the group timer.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A computer-implemented method for controlling a group timer only displayed to a subset of participants of a meeting of a plurality of participants, the computer-implemented method for execution on a computing device comprising:
generating a meeting object for managing permissions of the plurality of participants of the meeting, the meeting object further defining the start time of the meeting and an end time of the meeting, the meeting object defining permissions controlling communication of audio streams and video streams between the plurality of participants;
receiving a selection of the subset of participants for managing the group timer shared only within the subset of participants;
configurating the meeting object with permissions for controlling a display of the group timer, the permissions allowing the group timer to be displayed on the devices of the subset of participants, the permissions restricting the group timer from being displayed on the other devices of other participants that are not part of the subset of participants, the permissions allowing the devices of the subset of participants to maintain video and audio communication with the other devices of the other participants while the group timer is displayed on the devices of the subset of participants; and
using the permissions of the meeting object to cause a display of a user interface comprising the rendering of the group timer on the devices of the subset of participants, the permissions restricting the user interface comprising the rendering of the group timer from being displayed on the other devices of the other participants that are not part of the subset of participants, wherein the permissions cause the system to maintain at least one of the video communication and the audio communication between the devices of the subset of participants and other devices of the other participants while the group timer is displayed only on the devices of the subset of participants.

2. The computer-implemented method of claim 1, wherein the user interface is a second user interface, wherein the method further comprises:
causing a display of a first user interface comprising a meeting timer that is independently run from the group timer, the first user interface comprising at least one of a video stream or an image shared between a plurality of devices of the plurality of participants, wherein the first user interface is displayed prior to the display of the second user interface; and
transitioning the display of the first user interface on the devices of the subset of participants by replacing the first user interface with the second user interface having the group timer on the devices of the subset of participants, wherein the transition of the first user interface is performed while the first user interface is maintained on the other devices of the other participants that are not part of the subset of participants without providing an indication of the group timer to the other participants.

3. The computer-implemented method of claim 1, further comprising:
receiving an input indicating a duration of the group timer;
configuring the meeting object to store the duration of the group timer, the meeting object further comprising permissions to only permit the subset of participants to edit the duration of the group timer and to start the group timer;
receiving an input from one participant of the subset of participants to start the timer;
in response to the input to start the timer, starting the group timer and displaying an updated display of at least one of an elapsed time of the group timer or a remaining time of the group timer;
determining that the group timer is within a time threshold from the end of the duration or at the end of the duration; and
in response to determining that the group timer is within a time threshold from the end of the duration or at the end of the duration, causing an alarm to sound or generating a graphical notification on at least one device of the devices of the subset of participants.

4. The computer-implemented method of claim 1, wherein the permissions are configured to allow the subset of participants to transfer a display of the timer to an application operating in an operating system environment, the computer-implemented method further comprising:
receiving an input from at least one participant of the subset of participants to share a user interface of the application operating in the operating system environment;
in response to input from at least one participant of the subset of participants to share a user interface of the application operating in the operating system environment:
causing one or more devices of the plurality of devices to display the user interface of the application operating in the operating system environment; and
causing a display of the rendering of the group timer in conjunction with the display of the user interface of the application operating in the operating system environment.

5. The computer-implemented method of claim 1, further comprising: generating an animation within a frame of the user interface or within a background of a user interface, where in the animation changes display properties that include brightness or color changes, wherein A color or brightness changes to a darker shade indicating that the group timer is approaching the end or at the end of a duration of the timer.

6. The computer-implemented method of claim 1, further comprising: generating an animation representing the progress of the group timer between a start of the group timer up to the end of a duration of the group timer, where the animation transitions through individual scenes, where each transition between individual scenes starts at a first scene illustrating a theme indicating a start time of the group timer and ends at a last scene illustrating a theme indicating a time near an end of a duration of the group timer or at the end of the group timer.

7. The computer-implemented method of claim 1, further comprising:
determining milestones and a duration of the group timer, where the milestones have individual time periods, wherein the duration of the group timer and the time periods of the milestones are based on at least one of a user input indicating durations of each milestone or the duration, an analysis of the content a shared filed to determine durations of each milestone, or an analysis of an agenda to determine durations of each milestone; and
generating a graphical representation of the group timer showing the milestones and a marker showing a progress of the group timer after the group timer has started, and displaying an updated display of at least one of an elapsed time of the group timer or a remaining time of the group timer.

8. A computing system for controlling a group timer only displayed to a subset of participants of a meeting of a plurality of participants, the computing system comprising:
one or more processing units; and
a computer-readable storage medium having encoded thereon computer-executable instructions to cause the one or more processing units to:
generate a meeting object for managing permissions of the plurality of participants of the meeting, the meeting object further defining the start time of the meeting and an end time of the meeting, the meeting object defining permissions controlling communication of audio streams and video streams between the plurality of participants;
receive a selection of the subset of participants for managing the group timer shared only within the subset of participants;
configure the meeting object with permissions for controlling a display of the group timer, the permissions allowing the group timer to be displayed on the devices of the subset of participants, the permissions restricting the group timer from being displayed on the other devices of other participants that are not part of the subset of participants, the permissions allowing the devices of the subset of participants to maintain video and audio communication with the other devices of the other participants while the group timer is displayed on the devices of the subset of participants; and
use the permissions of the meeting object to cause a display of a user interface comprising the rendering of the group timer on the devices of the subset of participants, the permissions restricting the user interface comprising the rendering of the group timer from being displayed on the other devices of the other participants that are not part of the subset of participants, wherein the permissions cause the system to maintain at least one of the video communication and the audio communication between the devices of the subset of participants and other devices of the other participants while the group timer is displayed only on the devices of the subset of participants.

9. The computing system of claim 8, wherein the user interface is a second user interface, wherein the instructions further cause the one or more processing units to:
cause a display of a first user interface comprising a meeting timer that is independently run from the group timer, the first user interface comprising at least one of a video stream or an image shared between a plurality of devices of the plurality of participants, wherein the first user interface is displayed prior to the display of the second user interface; and
transition the display of the first user interface on the devices of the subset of participants by replacing the first user interface with the second user interface having the group timer on the devices of the subset of participants, wherein the transition of the first user interface is performed while the first user interface is maintained on the other devices of the other participants that are not part of the subset of participants without providing an indication of the group timer to the other participants.

10. The computing system of claim 8, wherein the instructions further cause the one or more processing units to:
receive an input indicating a duration of the group timer;
configure the meeting object to store the duration of the group timer, the meeting object further comprising permissions to only permit the subset of participants to edit the duration of the group timer and to start the group timer;
receive an input from one participant of the subset of participants to start the timer;
in response to the input to start the timer, starting the group timer and displaying an updated display of at least one of an elapsed time of the group timer or a remaining time of the group timer;
determine that the group timer is within a time threshold from the end of the duration or at the end of the duration; and
in response to determining that the group timer is within a time threshold from the end of the duration or at the end of the duration, cause an alarm to sound or generating a graphical notification on at least one device of the devices of the subset of participants.

11. The computing system of claim 8, wherein the permissions are configured to allow the subset of participants to transfer a display of the timer to an application operating in an operating system environment, wherein the instructions further cause the one or more processing units to:
receive an input from at least one participant of the subset of participants to share a user interface of the application operating in the operating system environment;
in response to input from at least one participant of the subset of participants to share a user interface of the application operating in the operating system environment:
cause one or more devices of the plurality of devices to display the user interface of the application operating in the operating system environment; and
cause a display of the rendering of the group timer in conjunction with the display of the user interface of the application operating in the operating system environment.

12. The computing system of claim 8, wherein the instructions further cause the one or more processing units to: generate an animation within a frame of the user interface or within a background of a user interface, where in the animation changes display properties that include brightness or color changes, wherein A color or brightness changes to a darker shade indicating that the group timer is approaching the end or at the end of a duration of the timer.

13. The computing system of claim 8, wherein the instructions further cause the one or more processing units to: generate an animation representing the progress of the group timer between a start of the group timer up to the end of a duration of the group timer, where the animation transitions through individual scenes, where each transition between individual scenes starts at a first scene illustrating a theme indicating a start time of the group timer and ends at a last scene illustrating a theme indicating a time near an end of a duration of the group timer or at the end of the group timer.

14. The computing system of claim 8, wherein the instructions further cause the one or more processing units to:
determine milestones and a duration of the group timer, where the milestones have individual time periods, wherein the duration of the group timer and the time periods of the milestones are based on at least one of a user input indicating durations of each milestone or the duration, an analysis of the content a shared filed to determine durations of each milestone, or an analysis of an agenda to determine durations of each milestone; and
generate a graphical representation of the group timer showing the milestones and a marker showing a progress of the group timer after the group timer has started, and displaying an updated display of at least one of an elapsed time of the group timer or a remaining time of the group timer.

15. A computer-readable storage medium having encoded thereon computer-executable instructions for controlling a group timer only displayed to a subset of participants of a meeting of a plurality of participants, the computer-executable instructions configured to cause one or more processing units of a computing system to:
generate a meeting object for managing permissions of the plurality of participants of the meeting, the meeting object further defining the start time of the meeting and an end time of the meeting, the meeting object defining permissions controlling communication of audio streams and video streams between the plurality of participants;
receive a selection of the subset of participants for managing the group timer shared only within the subset of participants;
configure the meeting object with permissions for controlling a display of the group timer, the permissions allowing the group timer to be displayed on the devices of the subset of participants, the permissions restricting the group timer from being displayed on the other devices of other participants that are not part of the subset of participants, the permissions allowing the devices of the subset of participants to maintain video and audio communication with the other devices of the other participants while the group timer is displayed on the devices of the subset of participants; and
use the permissions of the meeting object to cause a display of a user interface comprising the rendering of the group timer on the devices of the subset of participants, the permissions restricting the user interface comprising the rendering of the group timer from being displayed on the other devices of the other participants that are not part of the subset of participants, wherein the permissions cause the system to maintain at least one of the video communication and the audio communication between the devices of the subset of participants and other devices of the other participants while the group timer is displayed only on the devices of the subset of participants.

16. The computer-readable storage medium of claim 15, wherein the user interface is a second user interface, wherein the instructions further cause the one or more processing units to:
cause a display of a first user interface comprising a meeting timer that is independently run from the group timer, the first user interface comprising at least one of a video stream or an image shared between a plurality of devices of the plurality of participants, wherein the first user interface is displayed prior to the display of the second user interface; and
transition the display of the first user interface on the devices of the subset of participants by replacing the first user interface with the second user interface having the group timer on the devices of the subset of participants, wherein the transition of the first user interface is performed while the first user interface is maintained on the other devices of the other participants that are not part of the subset of participants without providing an indication of the group timer to the other participants.

17. The computer-readable storage medium of claim 15, wherein the instructions further cause the one or more processing units to:
receive an input indicating a duration of the group timer;
configure the meeting object to store the duration of the group timer, the meeting object further comprising permissions to only permit the subset of participants to edit the duration of the group timer and to start the group timer;
receive an input from one participant of the subset of participants to start the timer;
in response to the input to start the timer, starting the group timer and displaying an updated display of at least one of an elapsed time of the group timer or a remaining time of the group timer;
determine that the group timer is within a time threshold from the end of the duration or at the end of the duration; and
in response to determining that the group timer is within a time threshold from the end of the duration or at the end of the duration, cause an alarm to sound or generating a graphical notification on at least one device of the devices of the subset of participants.

18. The computer-readable storage medium of claim 15, wherein the permissions are configured to allow the subset of participants to transfer a display of the timer to an application operating in an operating system environment, wherein the instructions further cause the one or more processing units to:
receive an input from at least one participant of the subset of participants to share a user interface of the application operating in the operating system environment;
in response to input from at least one participant of the subset of participants to share a user interface of the application operating in the operating system environment:
cause one or more devices of the plurality of devices to display the user interface of the application operating in the operating system environment; and
cause a display of the rendering of the group timer in conjunction with the display of the user interface of the application operating in the operating system environment.

19. The computer-readable storage medium of claim 15, wherein the instructions further cause the one or more processing units to: generate an animation within a frame of the user interface or within a background of a user interface, where in the animation changes display properties that include brightness or color changes, wherein A color or brightness changes to a darker shade indicating that the group timer is approaching the end or at the end of a duration of the timer.

20. The computer-readable storage medium of claim 15, wherein the instructions further cause the one or more processing units to: generate an animation representing the progress of the group timer between a start of the group timer up to the end of a duration of the group timer, where the animation transitions through individual scenes, where each transition between individual scenes starts at a first scene illustrating a theme indicating a start time of the group timer and ends at a last scene illustrating a theme indicating a time near an end of a duration of the group timer or at the end of the group timer.
